(19) United States
(12) Patent Application Publication
(10) Pub. No.: US 2024/0402666 A1
(43) Pub. Date: Dec. 5, 2024

(54) METHOD FOR AUTOMATICALLY MAINTAINING AND IMPROVING A HYDRAULIC MODEL FOR A WATER DISTRIBUTION NETWORK, AND CONTROLLING THE OPERATION OF A WATER DISTRIBUTION NETWORK USING THE MAINTAINED HYDRAULIC MODEL

(71) Applicant: IMPERIAL COLLEGE INNOVATIONS LTD, London (GB)

(72) Inventors: Alexander WALDRON, London (GB); Filippo PECCI, London (GB); Ivan STOIANOV, London (GB)

(21) Appl. No.: 18/686,364

(22) PCT Filed: Aug. 24, 2022
(86) PCT No.: PCT/GB2022/052176

§ 371 Date: Feb. 23, 2024

(30) Foreign Application Priority Data
Aug. 24, 2021 (GB) 2112111.6

(51) Int. Cl. G05B 17/00; G06Q 50/06

(52) U.S. Cl. CPC G05B 17/00; G06Q 50/06

(57) ABSTRACT

A computer-implemented method of controlling operation of a water distribution network, WDN, comprising obtaining data pertaining to parameters of the WDN; comparing the data with a hydraulic model of the WDN; determining an error value based on the comparing the data with the hydraulic model; determining that the error value is below a threshold; using the data to obtain an updated hydraulic model; and using the updated hydraulic model to control one or more elements of the WDN.

### FIELD

The present disclosure relates to a method for automatically maintaining and improving (e.g. over time) a hydraulic model. A primary application of the maintained hydraulic model is to control the operation of a water distribution network. The maintained hydraulic model can also be applied for applications such as the detection and localisation of leaks and blockages (e.g. identify the unknown status of control valves).

### BACKGROUND

Hydraulic network models are used by water companies to understand the behaviour of their water distribution networks (WDNs) and undertake predictive work. Hydraulic models of WDNs are typically applied to simulate the distribution of pressure and flow within a WDN. Hydraulic models are an essential tool used by water utilities for supporting both near real-time operational tasks and long-term investment decisions in order to meet key performance indicators that may be imposed by regulatory bodies and/or other environmental and financial requirements. Applications, which depend upon accurate hydraulic models, include advanced pressure control, placement of control valves, leakage detection and localisation, blockage detection and localisation (e.g. closed or partially opened valves), pump scheduling and demand response, and the design, upgrade and control of WDNs. Consequently, a hydraulic model must be continuously maintained and improved over its life span. Otherwise, design and operational decisions might result in costly mistakes.

Traditionally, hydraulic models of WDNs should be detailed and incorporate vast numbers of pipes spanning most streets in urban environments, as well as rural areas, and the backbone of the network (i.e. large water transmission pipes from reservoirs and other water sources). The models are represented as mathematical graphs containing nodes (vertices) and links (edges) with various parameters. The parameters typically include water consumption data from residential and commercial properties, controls related information, elevations, and the lengths, diameters and roughness of pipes.

Determining such parameters (known as model calibration) is an expensive, time consuming, and typically is done manually. Consequently, water companies cannot often re-calibrate their traditional network models, resulting in network models that are quickly outdated and not accurate. For example, it is not unusual for a traditional network model to be up to 5 or more years old. There is therefore a need for a method of updating a hydraulic model of a WDN regularly and efficiently as hydraulic data (flow and pressure) become widely available.

The calibration of a hydraulic model is a process that compares simulation results with acquired hydraulic data (pressure and flow), and then automatically changes model parameters if necessary until the errors between simulation results and acquired hydraulic data are within pre-defined error bounds. Current calibration techniques for the hydraulic models of large WDNs are labour intensive and costly, and the model calibration is based only on a limited time period of operating conditions. As a result, once hydraulic models are calibrated, their performance may rapidly deteriorate due to changes in network connectivity, network specific parameters and hydraulic states.

It is therefore very important to have means of maintaining an accurate hydraulic model for a hydraulic network such as a WDN so as to ensure that the hydraulic model accurately represents the distribution of pressure and flow as hydraulic states change. Such changes may include different control settings being applied for control assets such as pumps and control valves, the occurrence of failure event(s), changes in network connectivity that are implemented following an incident response or because of the implementation of dynamically configurable networks, and/or a period of higher than expected customer demand due to, for example, industrial usage, large social events, or firefighting.

Each of these scenarios results in hydraulic states, which may substantially deviate from the initial set of hydraulic conditions used for model calibration. As a result, the inclusion of a larger variety of hydraulic states for model calibration maintains and improves the accuracy of a hydraulic model over time. However, the continuous inclusion of newly acquired hydraulic data with high spatial and temporal resolution presents major computational challenges for the calibration problem.

Previous attempts to improve the prediction of hydraulic models, that use continuously acquired hydraulic data, have involved the use of a combination of a Kalman filter and a recursive state estimator. Such methods consider every acquired hydraulic state, including data with faults in the system, which makes it difficult to distinguish between failures and normal operating conditions for networks with highly variable hydraulic conditions. Moreover, when extended time series of hydraulic data are considered, it is essential to know which hydraulic states to use for model calibration as using too many becomes computationally impractical.

Other previous attempts to improve the accuracy of hydraulic models have involved the use of fire flow tests, which seek to obtain a hydraulic model by increasing pipe flow velocities in the network. However, many water utilities, for example, in the UK, do not conduct fire flow tests as these tests are resource intensive, time consuming and potentially disruptive. Furthermore, it is not feasible to frequently perform fire flow tests to support continuous model maintenance.

It is thus desirable to have a method for maintaining and even improving over time an accurate model of a hydraulic network that addresses the above issues.

### SUMMARY

Aspects of the invention are set out in the independent claims. Optional features of aspects are set out in the dependent claims.

According to an aspect, there is provided a method of controlling operation of a water distribution network, WDN, comprising: (a) obtaining data pertaining to parameters of the WDN; (b) comparing the data with a hydraulic model of the WDN; (c) determining an error value based on the comparing the data with the hydraulic model; (d) determining that the error value is below a threshold; (e) using the data to obtain an updated hydraulic model; and (f) using the updated hydraulic model to control one or more elements of the WDN, and/or detect and localise failures.

The method may be computer-implementable, and thus may be computer-implemented.

The term water distribution network herein includes both water transmission and distribution mains, and associated control components

The hydraulic model of a water distribution network is a mathematical approximation of an operational water distribution network that simulates the hydraulic states, such as pressure and flow, in the network. Advantageously, determining an error value based on a comparison between the obtained data with an existing or a previous model and only using data when the error value is below a threshold, ensures that “outlier” data, which may, for example, be due to burst pipes, are not included in the calibration of the model. This, in turn, improves the accuracy of the updated model.

Optionally, the method may further comprise (g) obtaining further data pertaining to parameters of the WDN; (h) comparing the further data with the updated hydraulic model of the WDN; (i) determining a further error value based on the comparing the further data with the updated hydraulic model; (j) determining that the further error value is below the threshold; (k) using the data to obtain a further updated hydraulic model; and (l) using the further updated hydraulic model to control one or more elements of the WDN. Optionally, steps (g) to (l) may be repeated over time.

Advantageously, the continuous monitoring of the water distribution network and the updating and calibration of the hydraulic network using data that is continuously updated, ensures that the hydraulic model presents an accurate simulation of the hydraulic states in the water distribution network. This, in turn, leads to an improved and more accurate control of the network elements, which are controlled using the hydraulic model.

Optionally, the repetition over time may be performed periodically in regular or irregular time intervals.

Advantageously, the error value may be defined by the desired application of the model. For example, the threshold for the error value may be determined by the particular element(s) of the network that are controlled using the hydraulic model, and/or the requirements of the additional applications supported by the hydraulic model such as the detection and localisation of leaks, and blockages (e.g. closed control valves).

Optionally, determining an error value based on the comparing the data with the hydraulic model comprises determining a difference between the data and corresponding values in the hydraulic model and using the difference as the error value.

Optionally, if the error value is above the threshold, the method may further comprises: determining that the error value is not due to a fault in the WDN; and if the error value is not due to a fault, performing steps (e)-(f).

An advantage of determining whether or not outlier data is due to a fault in the network is that it ensures that while data related to faults in the system are not used for calibrating the model, large variations, which are naturally occurring are taken into account and are not dismissed as anomalies. This, in turn, improves the accuracy of a hydraulic model over time.

Optionally, determining that the error is not due to a fault in the WDN is performed using a density based anomaly detection method. Optionally, “Local Outlier Factor” (LOF) method may be used which compares an observed value against a previously known (and trusted) dataset.

An advantage of using a density based anomaly detection method such as LOF is that it ensures that samples which are outside the operational conditions of the network and indicative of a failure are discarded. By discarding this data, they are not included in the dataset that is used for updating the model, which increases the accuracy of the hydraulic model.

The WDN may comprise pipes, pumping stations, control valves, and reservoirs for supply of treated and untreated water.

The data may be obtained using one or more sensors and/or one or more flow meters in the hydraulic network.

The data may comprise passively observed naturally occurring variations in the state of the WDN over a particular time interval.

The parameters of the WDN may comprise at least one of pressure data of the WDN, flow rate data from links and customers within the WDN, state of pumps, state of control valves, and state of tanks.

Optionally, using the data to obtain an updated hydraulic model may comprise using the data to identify one or more states of the WDN; and using the one or more states to obtain the updated hydraulic model. This is, in essence, passive observation and identification of naturally occurring hydraulic variations in the network where data are observed and the hydraulic model is updated as new data is added to the model. This provides a large data set from which the “best data” can then be used to update the model.

Using the data to identify one or more states of the WDN may comprise identifying hydraulic states that are sufficiently different from previously observed hydraulic states.

The one or more states of the WDN may comprise pressure and flow data.

The one or more states may then be used to obtain an updated hydraulic model. Optionally, this may be done by adding the one or more states to a historic set of states of the WDN. That is, a dataset that was previously obtained from the WDN. In the absence of a historic dataset, the one or more states alone are used in the method. Once the one or more data sets are added to the historic dataset of states, this dataset is adaptively sampled to obtain a plurality of sampled states. The hydraulic model is then updated using the plurality of sampled states to obtain the updated hydraulic model.

The continuous inclusion of newly acquired online hydraulic data presents major computational challenges for the model calibration problem. An advantage of optimal identification of hydraulic states which involves sampling the very useful data and only using the sampled data in updating the model is that the hydraulic model may be updated accurately in a computationally efficient and fast manner.

Optionally, the time interval over which passively observed naturally occurring variations in the state of the WDN are observed is periodic and is regular or irregular, for example, with an upper limit of 24 hours. An advantage of a 24 hour time interval is that the interval captures activity over a full day, and asides from the weekends, weekdays are likely to have similar data. This, in turn, helps to capture anomalous data, which may be due to, for example, burst pipes and/or increased background leakage. Moreover, failures (e.g. bursts) have different impact on the hydraulic data and system states based on their size and location. Larger failures can be easier and faster to detect and localise, while smaller failures can be more difficult to detect and localise. In particular, smaller failures can be easier to detect and localise at night time because of the lower customer demand, which provides a higher “signal to noise ratio”. That is, the impact of failures on the hydraulic data and states at night time is more pronounced and “detectable” than during periods of peak customer demand. Therefore, observing data over a 24 hour time interval improves fault detection, which, in turn, improves the accuracy of the hydraulic model.

Optionally, adaptively sampling comprises using a principal component analysis, PCA, algorithm to identify, from a set of states of the WDN in the data, an optimal set of states, and using the optimal set of states as the plurality of sampled states.

An advantage of the novel use of this sampling technique in conjunction with sampling data from a WDN is that the algorithm evaluates the significance of newly observed hydraulic data to be included in the model calibration and maintenance such that a wide variation of data is included in the sample and repetitive data is excluded. This makes it possible to update the model using data that includes the necessary information without having to use all the data. This, in turn, improves the computational efficiency and speed of updating the hydraulic model.

Optionally, updating the hydraulic model using the plurality of sampled states comprises calibrating the hydraulic model with the plurality of sampled states using a sequential convex programming, SCP, algorithm.

An advantage of using SCP algorithm to incorporate the data into the hydraulic model is that it provides an optimal data fitting algorithm, which, in turn, provides an optimal calibration for the model.

Optionally, using the data to obtain an updated hydraulic model comprises: controlling the one or more elements of the WDN to alter the parameters of the WDN; obtaining modified data pertaining to the altered parameters of the WDN; generating one or more states of the WDN based on the modified data;

and using the one or more states to obtain the updated hydraulic model.

The one or more states of the WDN may comprise pressure and flow data.

This is active hydraulic control for the maintenance of a hydraulic model, which may be implemented by controlling one or more elements of the WDN, such as remotely actuated control valves, in order to generate particular hydraulic states.

Optionally, controlling the one or more elements of the WDN is contingent on a pressure in the WDN not exceeding pre-defined safe pressure bounds. The pre-defined pressure bounds may include minimum and maximum pressure for each node in the hydraulic model for the WDN.

The active control of network provides the opportunity to actively improve the accuracy of the hydraulic model over multiple control states without the need for traditional approaches such as fire flow tests. In active control, control settings may be “derived” for one or more elements, such as a set of control valves, to generate a new hydraulic state that is “significantly” different from a previously used hydraulic state, while at the same time not exceed safe bounds of minimum and maximum pressure. These one or more elements may be remotely actuated, such as remotely actuated control valves.

An advantage of maintaining the hydraulic model using active control is it achieves faster model maintenance compared to the method where passive control is implemented.

Optionally, the threshold for the error value may be defined based on the one or more elements that are controlled using the updated model. That is, the threshold may depend on the application of the hydraulic model.

This provides flexible control of operation of a WDN, whereby, the calibration of the hydraulic model may be tailormade by defining particular error thresholds depending on the application of the model, i.e. depending on the particular element(s) of the WDN that are controlled using the hydraulic model.

Optionally, the controlling the operation of the WDN may be performed over a network. That is, the one or more elements of the WDN are controlled remotely and online.

Optionally, the updating and maintenance of the hydraulic model is performed over a network.

According to another aspect, there is provided a computer readable medium comprising instructions executable by one or more processors to perform the method.

According to another aspect, there is provided a computer system comprising one or more processors to perform the method.

According to another aspect, there is provided a computer implemented method for maintenance of a hydraulic model of water distribution network, WDN, comprising: (a) obtaining data pertaining to parameters of the WDN; (b) comparing the data with a hydraulic model of the WDN; (c) determining an error value based on the comparing the data with the hydraulic model; (d) determining that the error value is below a threshold; and (e) using the data to obtain an updated hydraulic model.

Optionally, the method may further comprise (g) obtaining further data pertaining to parameters of the WDN; (h) comparing the further data with the updated hydraulic model of the WDN; (i) determining a further error value based on the comparing the further data with the updated hydraulic model; (j) determining that the further error value is below the threshold; and (k) using the data to obtain a further updated hydraulic model. Optionally, steps (g) to (k) may be repeated over time.

Optionally, the repetition over time may be performed periodically in regular or irregular time intervals.

Advantageously, the error value may be defined by the desired application of the model. For example, the threshold for the error value may be determined by the particular element(s) of the network that are controlled using the hydraulic model.

Optionally, determining an error value based on the comparing the data with the hydraulic model comprises determining a difference between the data and corresponding values in the hydraulic model and using the difference as the error value.

Optionally, if the error value is above the threshold, the method may further comprises: determining that the error value is not due to a fault in the WDN; and if the error value is not due to a fault, performing steps (e).

Optionally, determining that the error is not due to a fault in the WDN is performed using a density based anomaly detection method. Optionally, “Local Outlier Factor” (LOF) method may be used which compares an observed value against a previously known (and trusted) dataset.

The WDN may comprise pipes, pumping stations, control valves, and reservoirs for supply of treated and untreated water.

The data may be obtained using one or more sensors and/or one or more flow meters in the hydraulic network.

The data may comprise passively observed naturally occurring variations in the state of the WDN over a particular time interval.

The parameters of the WDN may comprise at least one of pressure data of the WDN, flow rate data of the WDN, state of pumps, state of control valves, and state of tanks.

Optionally, using the data to obtain an updated hydraulic model may comprise using the data to identify one or more states of the WDN; and using the one or more states to obtain the updated hydraulic model.

Using the data to identify one or more states of the WDN may comprise identifying hydraulic states that are sufficiently different from previously observed hydraulic states.

The one or more states of the WDN may comprise pressure and flow data.

The one or more states may then be used to obtain an updated hydraulic model. Optionally, this may be done by adding the one or more states to a historic set of states of the WDN.

Optionally, the time interval over which passively observed naturally occurring variations in the state of the WDN are observed is periodic and is regular or irregular, for example, with an upper limit of 24 hours.

Optionally, adaptively sampling comprises using a principal component analysis, PCA, algorithm to identify, from a set of states of the WDN in the data, an optimal set of states, and using the optimal set of states as the plurality of sampled states.

Optionally, updating the hydraulic model using the plurality of sampled states comprises calibrating the hydraulic model with the plurality of sampled states using a sequential convex programming, SCP, algorithm.

Optionally, using the data to obtain an updated hydraulic model comprises: controlling the one or more elements of the WDN to alter the parameters of the WDN; obtaining modified data pertaining to the altered parameters of the WDN; generating one or more states of the WDN based on the modified data; and using the one or more states to obtain the updated hydraulic model.

The one or more states of the WDN may comprise pressure and flow data.

Optionally, controlling the one or more elements of the WDN is contingent on a pressure in the WDN not exceeding pre-defined safe pressure bounds.

Optionally, the threshold for the error value may be defined based on the one or more elements that are controlled using the updated model. That is, the threshold may depend on the application of the hydraulic model.

Optionally, the controlling the operation of the WDN may be performed over a network. That is, the one or more elements of the WDN are controlled remotely and online.

Optionally, the updating and maintenance of the hydraulic model is performed over a network.

### BRIEF DESCRIPTION OF THE DRAWINGS

Specific embodiments are described below by way of example only and with reference to the accompanying drawings, in which:

FIG. 1 shows a method of controlling operation of a water distribution network.

FIG. 2 shows an example method of controlling operation of a water distribution network using passive observation and identification of naturally occurring hydraulic variations in a water distribution network.

FIG. 3 shows a flowchart for how model maintenance error may be obtained and used.

FIG. 4 shows an example method of controlling operation of a water distribution network using active generation of new hydraulic states for the water distribution network.

FIG. 5 shows a flowchart for how new hydraulic states may be generated.

FIG. 6 illustrates a block diagram of a computing device within which is a set of instructions, for causing the computing device to perform any one or more of the methodologies discussed herein.

### SPECIFIC DESCRIPTION OF CERTAIN EXAMPLE EMBODIMENTS

The invention outlined in this document aims to provide means for continuous maintenance of a hydraulic model of a water distribution network (WDN) in an accurate and computationally efficient manner such that the operation of the water distribution network is accurately controlled using the hydraulic model.

### Overview

In summary, the methods presented in this disclosure provide means for controlling operation of a water distribution network using continuous maintenance of the hydraulic model of the water distribution network in an accurate and computationally efficient manner. In this way, elements of the WDN such as pumps and valves can be controlled accurately using the hydraulic model. In order to provide accurate calibration of the hydraulic model, the method utilises large datasets. Advantageously, the method uses mathematical optimisation methods to validate the hydraulic states of a WDN in order to accept or reject a fault hypothesis for the operation of the WDN, thus discarding anomalous data. The method can implement passive and active control of the WDN using mathematical optimisation methods to identify and generate new hydraulic states for the WDN within pre-defined safe pressure bounds. Active control allows specifically designed hydraulic states to be generated in order to improve the model maintenance and identify undetected failure states.

A novel sampling method is applied to identify the best hydraulic states to be utilised in model calibration (parameter estimation process). The sampling method can, for example, use Principal Component Analysis (PCA)-based algorithms to determine time steps with the largest variety in their hydraulic states, such that a representative sample of data is used to train the hydraulic model against. Advantageously, the sampling method is independent of the chosen model fitting procedure and does not rely on a pre-existing hydraulic model, thus any parameter estimation method can be used in conjunction with the sampling method.

Furthermore, a tailored sequential convex programming (SCP) algorithm is used to calibrate the hydraulic model, i.e to solve the parameter estimation problem.

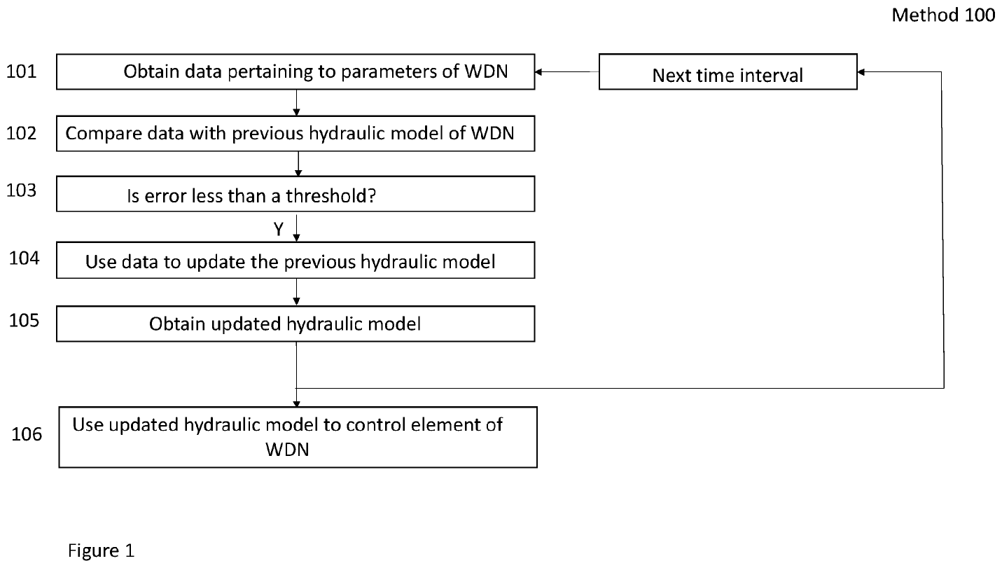

FIG. 1 depicts an example method 100 of controlling operation of a hydraulic network, such as a water distribution network (WDN), using a hydraulic model for the WDN. It is noted that although the method is described for a WDN, the method is equally applicable to any other hydraulic network, such as that described in Waldron et al (2020), “Regularization of an Inverse Problem for Parameter Estimation in Water Distribution Networks”, Journal of Water Resources Planning and Management, 146(9), 04020076, and Abraham and Stoianov (2016), “Sparse Null Space Algorithms for Hydraulic Analysis of Large Scale Water Supply Networks”, Journal of Hydraulic Engineering, 142 (3), DOI: 110.1061/(ASCE)HY.1943-7900.0001089. Other hydraulic networks might include urban district heating networks, such as that described in Vesterlund and Dahl (2015), “A Method for the Simulation and Optimization of District Heating Systems with Meshed Networks”, Energy Conversion and Management, 89 (1), DOI: https://doi.org/10.1016/j.enconman.2014.10.002

A WDN typically comprises pipes, pumping stations, control valves, as well as reservoirs for supply of untreated (raw) and treated (potable) water. Such data may relate to naturally occurring hydraulic variations in a WDN. An objective of continuous maintenance of the hydraulic model is to ensure that the hydraulic model accurately represents the distribution of pressure and flow as hydraulic states change. This then enables accurate control of the WDN using the hydraulic model.

A hydraulic state defines the pressure at every node and flow velocity at every pipe in a hydraulic model of a water distribution network. A hydraulic state may also includes the state of control components such as valves and pumps.

Such changes to hydraulic state may include, for example, (i) different control settings being applied for control assets such as pumps and control valves, (ii) the occurrence of failure event(s), (iii) changes in network connectivity being implemented following an incident response or because of the implementation of dynamically configurable networks, and/or (iv) a period of higher customer demand due to, for example, industrial use, social events, or firefighting.

Each of the above scenarios may result in hydraulic states, which may substantially deviate from the initial set of hydraulic conditions used for calibrating the hydraulic model of the WDN. As a result, the inclusion of a larger variety of hydraulic states for model calibration maintains and improves the accuracy of a hydraulic model over time. There are several intrinsic advantages of continuously maintaining a hydraulic model in comparison to periodically recalibrating it. Firstly, recalibrating a WDN using a new dataset does not take advantage of knowledge on state variations included in previous hydraulic data. Secondly, the hydraulic model may not have a good prediction accuracy for dynamic control states (e.g. valve/pump settings or topology), which were not included in the original model calibration. Thirdly, calibration exercises are time consuming and expensive, and they may need to be undertaken by experienced individuals. It is therefore preferable to reduce the number of independent model fitting exercises.

Referring back to FIG. 1, method 100 illustrates a novel approach for model calibration. At step 101, data pertaining to parameters of the WDN is obtained. This data may relate to the distribution of pressure and flow in the network and may be acquired using sensors such as pressure sensors and flow meters, which are placed at different points in the network. Data may be acquired remotely, for example, online, from these sensors and meters. The data may then be used to calibrate an existing model for the WDN.

At step 102, the obtained data is compared with an existing or a previously obtained hydraulic model for the WDN in order to filter out “outliers” in the data. Such outliers may be present due to the presence of a fault in the network, such as a burst pipes. An advantage of identifying anomalous data is that they are not included in the dataset that is used for calibrating the hydraulic model, so that the hydraulic model maintains its accuracy.

The comparison between the obtained data and the existing hydraulic model yields an error value which may be determined by determining a difference between the data and the corresponding values in the existing or a previously obtained hydraulic model. Identifying anomalous data or detecting faults in the network based on the error value may be performed using a density-based outlier detection method. An example of such a method is “Local Outlier Factor” (LOF) which compares an observed value against a previously known (and trusted) dataset.

The existing or previous hydraulic model may be used to set a threshold for the error value or an acceptable LOF value. The threshold for the error value may, in turn, depend on the elements of the network that are being controlled by the hydraulic model. For example, a different threshold value is set when the elements being controlled are pumps to when the elements are valves. Examples of threshold values for different elements in a network are provided in Waldron et al (2020), “Regularization of an Inverse Problem for Parameter Estimation in Water Distribution Networks”, Journal of Water Resources Planning and Management, 146(9), 04020076.

At step 103a, if the error value is below a threshold, then method 100 proceeds to step 104, where data may be used for updating the hydraulic model.

If, at step 103a, it is determined that the error value is above the acceptable threshold, then, at step 103b, it is determined whether or not the error is due to a fault. If it is determined that the error is due to a fault in the network, then the method may proceed to step 103c, where the fault may be localised in the network. That is, the location of the fault in the network is determined, or a small area of pipes are identified which most likely include the fault (e.g. a leakage hotspot area). Examples of the use of LOF for detecting and localising faults in a network, which may be used in the present method are detailed in papers by Pecci, F., Parpas, P. & Stoianov, I. (2020), “Sequential Convex Optimization for Detecting and Locating Blockages in Water Distribution Networks”, Journal of Water Resources Planning and Management. 146 (8), Blocher, C., Pecci, F. & Stoianov, I. (2020), “Localizing Leakage Hotspots in Water Distribution Networks via the Regularization of an Inverse Problem”, Journal of Hydraulic Engineering. 146 (4), Mounce, S. R., Day, A. J., Wood, A. S., Khan, A., et al. (2002), “A neural network approach to burst detection”, Mounce, S. R., Mounce, R. B. & Boxall, J. B. (2011), “Novelty detection for time series data analysis in water distribution systems using support vector machines”, Journal of Hydroinformatics. 13 (4), and Palau, C. V, Arregui, F J & Carlos, M. (2012), “Burst Detection in Water Networks Using Principal Component Analysis”.

If, however, it is determined that the error is not due to a fault, then the method proceeds to step 104.

The use of data at step 104 may depend on the stage of the calibration of the model. For example, if the data obtained is an initial dataset and no other data has been obtained in a previous time interval, then all the obtained data may be used for updating the model. On the other hand, if data has been obtained over an extensive timeseries, then it may be more computationally efficient to only select a sample of the obtained data to update the model.

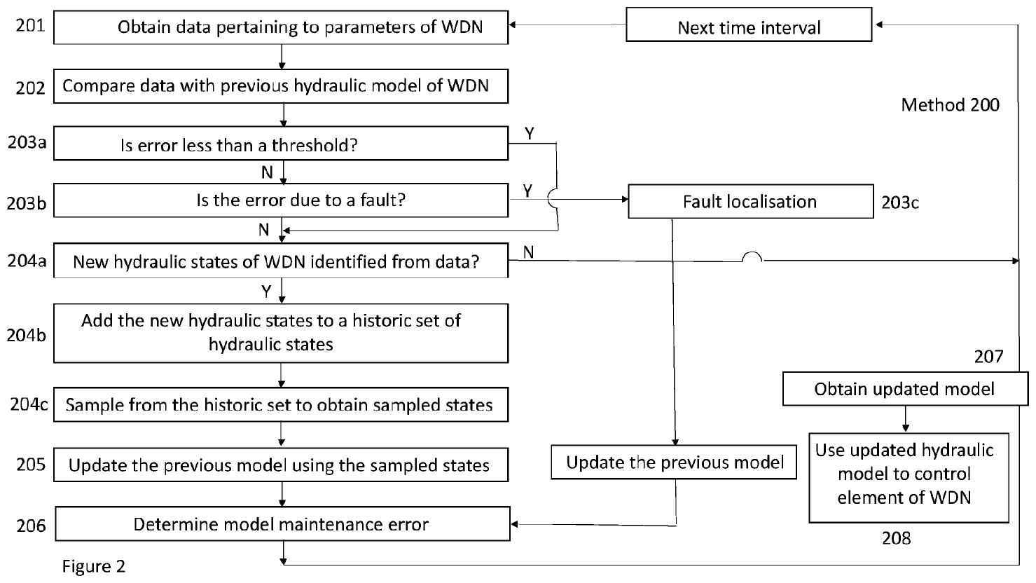

Optionally, the use of data at step 104 may entail passive observation and identification of naturally occurring hydraulic variations in a WDN, which sufficiently differ from previously observed hydraulic states. The passive monitoring of the WDN is described in more detail with reference to FIG. 2.

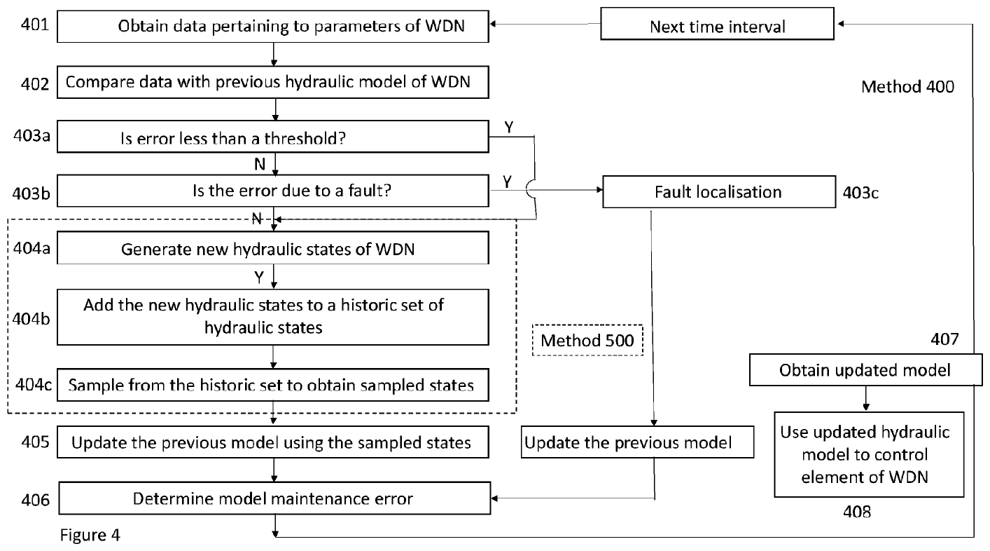

Optionally, the use of data at step 104 may entail active generation of hydraulic states which are different from previously observed hydraulic states. In the active generation approach, the obtained data is used to “derive” new hydraulic states for the WDN, where control settings are derived for a set of control valves to generate a new hydraulic state that is “significantly” different than a previously used hydraulic state. The active control approach for a WDN is described in more detail with reference to FIG. 4.

At step 105, an updated hydraulic model is obtained. Obtaining an updated hydraulic model may involve fitting the existing or previously obtained model against the data. Advantageously, the fitting of the existing model against the data is independent of the existing model and any fitting algorithm, for example, the least squares method, may be used at step 105. The least squares method is a statistical procedure to find the best fit for a set of data points by minimising the sum of the offsets or residuals of points from the existing model. An approach analogous to that proposed by Do et al. (2018) and Waldron et al. (2020) may also be used to fit the existing model against the data. This is explained in more detail with reference to FIG. 2.

At step 106, the updated hydraulic model of the WDN is used to control one or more elements of the WDN. These elements can, for example, be pumps or valves located across various point in the WDN, and the updated hydraulic model, can, for example, determine the operation of these elements depending on the pressure and flow rates in the updated model.

Optionally, in order to continuously maintain and improve the accuracy of the updated model, data may be acquired from the WDN at particular time intervals, for example, periodically, at regular or irregular time intervals (say, every 24 hours or less). To this end, once a model is updated at step 105, the method loops back to step 101, where a new set of data is acquired. The newly acquired data is then compared with the model that was updated at step 105 and the procedure can be repeated in this loop, thus continuously updating the hydraulic model. In this way, method 100 may provide continuous monitoring and adaptive control of the WDN by continuously monitoring and gathering data from the WDN and updating the hydraulic model of the WDN using the hydraulic data such that elements of the network may be accurately controlled using an updated hydraulic model.

FIG. 2 depicts an example method 200 of controlling operation of a water distribution network using passive observation and identification of naturally occurring hydraulic variations in a WDN. The method steps are analogous to the steps of method 100, where step 104—using data to update the previous hydraulic model—is performed using passive observation and identification of naturally occurring hydraulic variations in a WDN, as set out in steps 204a-204c.

In an analogous manner to FIG. 1, if at step 203a it is determined that the error is not due to a fault, then the method proceeds to step 204a. At step 204a, the data is used to identify new hydraulic states. Hydraulic states are considered to be new hydraulic states if the obtained data presents hydraulic variations in the WDN which are sufficiently different from previously observed hydraulic states in the existing or previously obtained hydraulic model.

If new hydraulic states are not identified, then the method proceeds back to step 201, where more data is collected after a particular time interval.

If, on the other hand, new hydraulic states are identified, then the new states are added to a historic set of hydraulic states at step 204b. Such a historic set may have been obtained at a previous time interval(s) when data was obtained for the WDN. Where a historic set of hydraulic states is not available, for example, when data is obtained for the WDN for the first time, then the method proceeds directly to step 204c.

The continuous inclusion of newly acquired hydraulic data presents major computational challenges when it comes to calibrating a previous or an existing model of the WDN. This is because as more data is collected over time, the size of the data set becomes so large that the inclusion of the data set in calibrating the hydraulic model becomes computationally impractical.

A solution to this problem, as outlined in method 200, is to select a sample of the hydraulic states that maximise the hydraulic information that is contained in the dataset that is used to calibrate the WDN hydraulic models. Therefore, the optimal identification of hydraulic states, which provide novel information, is important for the inclusion of an optimum sample dataset in the hydraulic model calibration process.

Once the historic data set is updated to include the new hydraulic states at step 204b, the method proceeds to step 204c, where a sample dataset is obtained from this historic set of hydraulic states. An approach for sampling such that the hydraulic information in the training dataset used for calibrating WDN hydraulic models is maximised, is Principal Component Analysis (PCA). PCA is applied in machine learning for linearly reducing the dimensionality of data into uncorrelated components, as described, in for example, Jackson, 1991; Jolliffe, 2002; Lee and Verleysen, 2007; Shalizi, 2013, Chapter 15; and James et al., 2013, Chapter 10.2. Reducing dimensions using PCA improves the interpretability of the data and allows for less significant components to be discarded, which improves the signal to noise ratio in the acquired hydraulic data.

Principal component analysis may be used to sample from a set of hydraulic states in the following way.

### Sampling Using PCA

Let ĥₜ∈Rⁿ^{ₕ} and \hat{q}ₜ∈Rⁿ^{_{q}} be vectors of pressure and flow measurements at time step t, respectively, where nₕ is the number of pressure loggers, n_{q} is the number of flow meters in the WDN, and where time step t represents a hydraulic state. Here, R is the set of real numbers. A vector yₜ:=[ĥₜ^{T},\hat{q}ₜ^{T}]^{T} of length n_{y}=nₕ+n_{q} is defined so that the nₜ by n_{y} matrix of hydraulic data for nₜ time steps

$$Y := {[ {y}_{{t}_{1}} , … , {y}_{{t}_{{n}_{t}}} ]}^{T} .$$

In this way, Y combines pressure and flow measurements, which are used at step 205 to calibrate the hydraulic model. The objective here is to find a unit vector w∈Rⁿ^{_{y}} that represents the direction where each yₜ can be projected such that a maximum possible variance over the considered nₜ time steps is obtained. Implementing PCA allows for w to be determined via eigen decomposition on the covariance matrix of Y, such that:

Σw=λw,

w^{t}w=1

where Σ represents the covariance matrix of Y and λ is an eigenvalue. Note that w is equivalent to an eigenvector of Σ and λ. The covariance matrix Σ is always a positive definite (or positive semi-definite) matrix of size n_{y}×n_{y}, hence implying that there are no more than n_{y} eigenvalues (or nₜ<n_{y} eigenvalues if Σ is singular), and that the eigenvalues are non-negative. Pairs of eigenvalues and associated non-trivial eigenvectors can thus be efficiently calculated. The symmetric quality of Σ also implies that these eigenvectors are orthogonal, meaning that each eigenvector corresponds to a different uncorrelated dimension. Therefore, the dimension with the largest eigenvalue λ₁ has the largest variance, the dimension with the second largest eigenvalue λ₂ has the second largest variance, and so on up to the n_{y}th dimension.

When reducing high dimensional data into its principal components, finer variations between time steps are captured for every added principal component dimension. However, using too many components leads to overfitting (or overestimation) on the dataset, as the inherent uncertainty associated with down-sampled hydraulic data can lead to many of the observed variations being unhelpful and detrimental. Conversely, using too few components leads to underfitting (or underestimation) on the dataset. Therefore, a right number of components are selected to capture the important information in the dataset without introducing errors.

The problem of determining the number of non-trivial principal components to be used, hence providing a meaningful interpretation of the data, has been extensively studied in, for example, Horn, 1965; Cattell, 1966; Frontier, 1976; Efron, 1979; Jackson, 1993; Jolliffe, 2002; Peres-Neto et al., 2005; and Vieira, 2012, etc. The method used in method 200 implements the Kaiser-Guttman method (Guttman, 1954; Kaiser, 1991). Using this method, the principal components to be used is defined as (λⱼ)_{j∈N}_{_{pc}}, where

$${N}_{p c} = \{ \begin{matrix}i \vert {λ}_{i} > 1 , & i ∈ \{ 1 , … , {n}_{y} \} \}\end{matrix}$$

Let n_{pc}=|N_{pc}|, wⱼ be the eigenvector corresponding to the principal component λⱼ, i.e.

Σwⱼ=λⱼwⱼ∀ⱼ∈N_{pc}

and W∈Rⁿ^{_{y}}^{×n}^{_{pc}} be a matrix where each column corresponds to an eigenvector wⱼ for all j∈N_{pc}, then matrix S, where:

S=YW

is a nₜ×n_{pc} matrix where each row represents a time step and each column represents a different projection on an orthogonal dimension. Therefore, S provides principal components projections of the hydraulic data.

In this way, the sampling algorithm identifies, from a time series of hydraulic data, a set of time steps T* which provide the most information and represent the best set of hydraulic states for the hydraulic model to be fitted against. Given a new set of time steps T, the algorithm iteratively updates the current best selection T* by evaluating whether it can be improved by individual time steps t∈T. The algorithm may also check whether t contains anomalies (e.g. bursts) or has made any of the previously selected time steps redundant.

An advantage of designing an algorithm which can evaluate individual time steps against the current selected set is the flexibility it offers. This includes the full spectrum of options from periodically evaluating large batches of data (where |T| is large) to near real-time applications (where |T| approaches 1). Furthermore, the sampling procedure does not require a hydraulic model, hence the more computationally expensive parameter estimation (model calibration) and updating process is only implemented after each time step in T has been considered.

The algorithm may start by initialising T₀ corresponding to a training data computed at a previous implementation of the algorithm or as an empty set (T₀=Ø). The algorithm may then be applied with a new set of data T and T*=T₀, producing a sampled T*. If T* differs from T₀, the current model is updated by fitting it against the dataset corresponding to T*. This process is repeated when a new set T becomes available.

### Model Calibration (Parameter Estimation)

Referring back to FIG. 2, once a set of sampled hydraulic states have been obtained, the method proceeds to step 205, which involves the use of sampled states to update the existing or a previous hydraulic model. An advantage of the sampling method, described above, is its flexibility as the data obtained is independent of the hydraulic model against which the data is fitted. The sampling is also independent of the calibration algorithm that is used for fitting the existing model against the sampled data, i.e. it is independent of the calibration algorithm.

The calibration and updating of the hydraulic model at step 205 may involve solving a parameter estimation problem to fit the hydraulic model against the sampled hydraulic states corresponding to time steps in T*. An approach that may be used in this regard is a data driven reallocation approach analogous to that set out in Do et al. (2018) and Waldron et al. (2020), which scales the demand at each network node for each time step depending on the ratio between the measured water used in an area and the predicted water used in the area. Moreover, the model considers uₜ∈Rⁿ^{ᵥ} as the vector of known control inputs defined by data for nᵥ control valves at t∈T*. The inlet and outlet hydraulic heads, as well as flow across the control valves are measured. Given k∈{1, . . . , nᵥ}, the control input u_{k,t} is calculated as the head loss between inlet and outlet nodes, given by:

$${u}_{k , t} = {\hat{h}}_{i n ( k ) , t} - {\hat{h}}_{out ( k ) , t} - {∅}_{k} ( {\hat{q}}_{k , t} ) \qquad ( 1 )$$

where ĥ_{in(k),t} and ĥ_{out(k),t} are the measured hydraulic heads at nodes corresponding to inlet and outlet of control valve k. Moreover, Øₖ(\hat{q}_{k,t}) denotes the minor loss across the valve, which can be calculated from the measured flow \hat{q}_{k,t}.

The link-node incidence matrices for both the known and unknown heads are denoted by A₁₂∈Rⁿ^{ₚ}^{×n}^{ₙ} and A₁₀∈Rⁿ^{ₚ}^{×n}^{₀}, respectively, and the link-control valve incidence matrix A₁₃∈Rⁿ^{ₚ}^{×n}^{ᵥ}. Energy and mass conversation is given by:

$$Φ ( {q}_{t} , c ) + {A}_{12} {h}_{t} + {A}_{10} {h}_{0 t} + {A}_{13} {u}_{t} = 0 \qquad ( 2 )$$

$${A}_{12}^{T} {q}_{t} - {d}_{t} = 0 \qquad ( 3 )$$

Here, c∈Rⁿ^{ₚ} is the vector of roughness coefficients and Φ(qₜ,c) is the head loss model, usually defined by the Hazen-Williams or Darcy-Weisbach formulae (Larock et al., 1999). Unknown hydraulic heads hₜ^{T} and flows qₜ^{T} at time t may be found using a null space Newton method (Abraham and Stoianov, 2015), and xₜ:=[hₜ^{T},qₜ^{T}]^{T} may be defined. Given a vector of roughness coefficients c∈Rⁿ^{ₚ}, a unique vector of hydraulic states xₜ(c), solves equations (2) and (3), for all t∈T*. Hence, the considered hydraulic model defines functions c→xₜ(c), t∈T*, and the model error, Ψ(c) can be defined as the summation of the squared l₂-norms of the residuals between n_{y} hydraulic measurements and model predictions at each time step, given by:

$$Ψ ( c ) = \frac{1}{2 \vert {T}^{*} \vert} {\sum }_{t ∈ T *} {‖ {Ax}_{t} ( c ) - {y}_{t} ‖}_{2}^{2} \qquad ( 4 )$$

where yₜ∈Rⁿ^{_{y}} is the vector of hydraulic measurements at time t and A∈Rⁿ^{_{y}}^{x(n}^{ₚ}^{×n}^{ₙ}⁾ is the logger-node/link incidence matrix. The nonlinear least squares optimisation problem for parameter estimation is then formulated as follows:

$$minimise Ψ ( c ) subject to {c}_{min} \leq c \leq {c}_{max} \qquad ( 5 )$$

where cₘᵢₙ, cₘₐₓ∈R⁺ enforce the roughness coefficient values to be positive and within a realistic range. Problem (5) is usually significantly underdetermined, as the number of measurements is far fewer than the number of roughness coefficients (nₚ). Common ways of circumventing this issue include grouping the number of pipes, to reduce the number of variables (e.g. Mallick et al., 2002; Kumar et al., 2010), or using regularisation with statistical learning techniques, to reduce ill-posedness (Waldron et al., 2020). Using a wider variety of hydraulic states improve the robustness of the solution by utilising naturally occurring variations in a WDN over time.

Although Problem (5) is a non-convex non-linear program, it is possible to compute locally optimal solutions using gradient-based optimisation methods. A solution proposed in the present application is that of tailoring a sequential convex programming (SCP) algorithm, which has been previously applied for solving fault estimation problems in WDNs, as set out in Pecci et al., 2020, “Sequential Convex Optimization for Detecting and Locating Blockages in Water Distribution Networks”. Journal of Water Resources Planning and Management, 146(8). An advantage of using the SCP algorithm is the relative simplicity of its implementation and its additional flexibility when considering non-smooth objective functions (e.g. l₁ regularisation, Huber regression, etc.), hence allowing the incorporation of additional strategies for dealing with noise and ill-posedness in the data if required.

The method proposed here is a l₂ formulation for parameter estimation with a data driven demand reallocation approach for state estimation.

The SCP method minimises a convex approximation of the initial objective function from Equation (4) within a trust-region radius of Δ^{k}>0 at iteration k. This leads to a new problem being formulated which relies on the solution estimate at iteration k to find the next estimate for k+1. The problem is as follows:

$$\begin{matrix}minimise & \frac{1}{2 \vert {T}^{*} \vert} {\sum }_{t ∈ {T}^{*}} {‖ A ( {x}_{t} ( {c}^{k} ) + {J}_{{x}_{t}} ( {c}^{k} ) ( c - {c}^{k} ) ) - {y}_{t} ‖}_{2}^{2} \\ subject to & {‖ c - {c}^{k} ‖}_{∞} \leq {Δ}^{k} \\ & {c}_{min} \leq c \leq {c}_{max}\end{matrix}$$

where Jₓ_{ₜ}(c^{k}) is the Jacobian matrix of xₜ(⋅) evaluated at c^{k}. The algorithm starts with a set value for Δ⁰, increasing or decreasing the size of Δ^{k+1} by a predetermined factor depending on whether the approximated objective function results in substantial progress. Eventually the algorithm terminates when either the solution or the relative change in the solution or trust-region radius are below a given tolerance. Examples of parameter that may be used for method 200 are set out in, Pecci et al. (2020) “Sequential Convex Optimization for Detecting and Locating Blockages in Water Distribution Networks”. Journal of Water Resources Planning and Management, 146(8). Details on how to calculate Jₓ_{ₜ} for both the Hazen-Willams and Darcy-Weisbach roughness coefficients can be found in Waldron et al. (2020), “Regularization of an Inverse Problem for Parameter Estimation in Water Distribution Networks. Journal of Water Resources Planning and Management”, 146(9):04020076.

Therefore, at step 205, SCP algorithm may be used in the manner outlined above to update the hydraulic model in a computationally efficient manner.

### Model Maintenance Error

Optionally, once the parameter estimation problem is solved at step 205 and the model is updated by fitting the model against the sampled states, method 200 proceeds to determining the accuracy of the obtained model. This step improves the accuracy of the model as it ensures that only an updated model that is an improvement on a previous model is used.

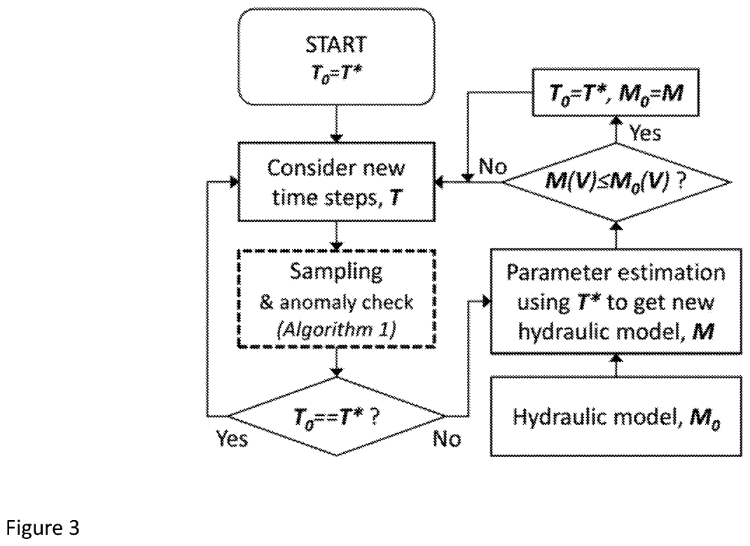

Step 206 is described with reference to FIG. 3, which depicts a flowchart for how model maintenance error is obtained and used according to method 200. With reference to FIG. 3, the accuracy of the model updated with T* is evaluated using a maintenance error, which is the model prediction error on a sub-sample of data corresponding to all previous non-anomaly time steps V. If the model maintains its accuracy over time, the maintenance error should remain constant, irrespective to changes in the control state.

Advantageously, the maintenance error can be used to observe if the model is being maintained, but also to verify that the most recent model M is at least as good as the previous model M₀ on V. If it is not, M can be disregarded, as shown in FIG. 3.

Updating the hydraulic model can optionally include information on fault localisation obtained at step 203c.

Once the model is updated at step 205, there are a number of different ways that the set of time steps V for the validation of M may be defined. As an example, V may be set to be a combination of previous non-anomaly time steps and, where possible, non-sampled time steps. When enough time steps are available, it is preferable to keep the “training” set T and the “validation” set V independent, i.e. T*∩V=Ø, so as to avoid overfitting the model.

In this way, not only is the accuracy of the updated model is maintained, the method also ensures that the most recent updated model is at least as accurate as the previous hydraulic model.

The updated model may then be used at step 208 to control one or more elements of the WDN, as described in relation to step 106 of FIG. 1. These elements can, for example, be pumps or valves located across various point in the WDN, and the updated hydraulic model, can, for example, determine the operation of these elements depending on the pressure and flow rates in the updated model. Optionally the pumps and/or valves may be remotely actuated and the operation of the pumps and/or valves may be controlled using the updated model. For example, the operation of the pumps and/or valves may be adjusted according to the hydraulic model to adjust the pressure and flow at particular times in a day and in particular areas of the network. Improved accuracy in the hydraulic model thus improves the accuracy of these controls and adjustments, which, in turn, improves the performance of the hydraulic network.

As described in relation to FIG. 1, in order to continuously maintain and improve the accuracy of the updated model, data may be acquired from the WDN at particular time intervals, for example, every 24 hours. To this end, once a model is updated at step 207, the method loops back to step 201, where a new set of data is acquired. The newly acquired data is then compared with the model that was updated at step 205 and the procedure can be repeated in this loop, thus continuously updating the hydraulic model. In this way, method 200 provides continuous monitoring and adaptive control of the WDN by continuous passive monitoring and gathering data from the WDN and updating the hydraulic model of the WDN using an optimum set of hydraulic data such that elements of the network may be controlled using an accurate hydraulic model.

FIG. 4 depicts an example method 400 of controlling operation of a water distribution network using active generation of new hydraulic states for the WDN. This is very similar to the method described with reference to FIG. 2, with a difference that whereas method 200 in FIG. 2 used passive observations of naturally occurring hydraulic variations alone to identify new hydraulic states, method 400, described with reference to FIG. 4, involves the use of passive observations as well as active derivation of hydraulic states for the WDN.

Maintaining and calibrating a hydraulic model of a WDN using “passive control”, as set out in FIG. 2, operates a “build and maintain” process where the hydraulic model is continuously monitored and updated (maintained) over time by taking advantage of naturally occurring variations in the WDN or responses to events (passive sampling). The “active control” method, set out in FIG. 4, takes this one step further. In the active control method 400, the boundary conditions in the WDN are intentionally adjusted with the aim of obtaining a new optimal set of hydraulic conditions for the measurements obtained from, for example, pressure sensors/loggers, to fit the existing or previously obtained model against. That is, in method 400, the control settings for the elements of the WDN, such as remotely actuated control valves, are “derived” in order to generate a new hydraulic state that is “significantly” different from a previously used hydraulic state.

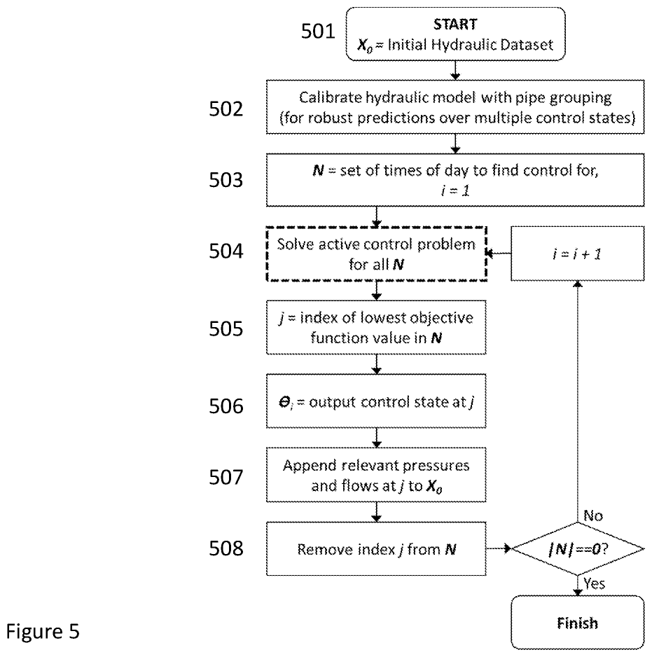

Referring back to FIG. 4, steps 401-403b of method 400 are the same as the steps 201-203b of method 200 in FIG. 2. Steps 404a-404c in FIG. 4 are analogous to steps 204a-205c in FIG. 2, with a difference that the identification of new hydraulic states is replaced with the generation of new hydraulic states of WDN. The generation of new hydraulic states with reference to steps 404a through to step 404c is described with reference to FIG. 5.

With reference to FIG. 5, the process of generating new hydraulic states starts at step 501 with an initial hydraulic dataset (X₀) which is obtained at step 401. The data can optionally encompass all previous control and consumer demand patterns. This can, for example, be the data collected during a time interval (for example, a 24 hour period) of data after the data is collected from the WDN. Optionally, the data may be collected from pressure sensors and/or flow meters in the WDN. Once the different hydraulic states are captures at X₀ the process is aimed at finding the optimal hydraulic states which complement the data already captured in X₀.

The process then proceeds to step 502, where the existing or previously obtained hydraulic model is calibrated using a parameter estimation method akin to that described by Waldron et al in “Regularization of an Inverse Problem for Parameter Estimation in Water Distribution Networks”, J. Water Resour. Plann. Manage., 2020, 146(9).

At step 503, the set of times (N) during a time interval, say a day, for which the control conditions (i.e. the new hydraulic states) are sought is chosen. Set N is useful for practical purposes because changing control conditions too regularly may not be practical. For example, N may contain each hour of the day as that is likely to be the highest frequency with which water companies are happy to change the control settings in the network.

The method then proceeds to step 504 where the active control problem for each element in set N is solved. That is, the control setting for each element, such as a valve or pump, in set N is changed and the hydraulic state which gives the best result with respect to X₀ is chosen. The problem to be solved here is a non-linear programming (NLP) problem, which may be solved using interior point optimiser (IPOPT) in a manner described in https://coin-or.github.io/lpopt/and https://github.com/coin-or/lpopt; see also Pecci, Parpas and Stoianov (2020), “Sequential Convex Optimization for Detecting and Locating Blockages in Water Distribution Networks”, Journal of Water Resources Planning and Management, 146(8), DOI: 10.1061/(ASCE) WR.1943-5452.0001233.

At step 505, the element from set N which produced the best solution to the problem at step 504 (i.e. the lowest objective function value) is chosen.

At step 506, the control output for this element is saved to a parameter (θ₀) and at step 507, the hydraulic output at the pressure sensors and/or flow meters is appended to X₀ using this control setting. This is then repeated until N is empty. An advantage of running the algorithm of FIG. 5 in this way is that as each new set of control conditions (hydraulic states) generated are beneficial not just with respect to X₀, but also with respect to each generated hydraulic state chosen on previous iterations.

In this manner, an optimal set of hydraulic states is generated, which can then be used to update a previous hydraulic model.

Referring back to FIG. 4, the set of optimum hydraulic states generated are used at step 405 to update the previous hydraulic model. The updating of the model uses the same model calibration technique as that described for step 205 with reference to FIG. 2.

Updating the hydraulic model can optionally include information on fault localisation obtained at step 403c.

Similarly, step 406 may be performed in the same way as step 206 in FIG. 2 to determine the model maintenance error.

The updated model may then be used to control one or more elements of the WDN, as described in relation to step 106 of FIG. 1. These elements can, for example, be pumps or valves located across various point in the WDN, and the updated hydraulic model, can, for example, determine the operation of these elements depending on the pressure and flow rates in the updated model. Optionally the pumps and/or valves may be remotely actuated and the operation of the pumps and/or valves may be controlled using the updated model. For example, the operation of the pumps and/or valves may be adjusted according to the hydraulic model to adjust the pressure and flow at particular times in a day and in particular areas of the network. Improved accuracy in the hydraulic model thus improves the accuracy of these controls and adjustments.

As described in relation to FIG. 1, in order to continuously maintain and improve the accuracy of the updated model, data may be acquired from the WDN at particular time intervals, for example, every 24 hours. To this end, once a model is updated at step 407, the method loops back to step 401, where a new set of data is acquired. In this way, method 400 provides continuous monitoring and adaptive control of the WDN by deriving optimum new hydraulic states for the WDN and updating the hydraulic model of the WDN using this optimum set of hydraulic states such that elements of the network may be controlled using an accurate hydraulic model. An advantage of active control for maintaining the hydraulic model is the speed with which the model can be updated because hydraulic states are generated rather than passively observed.

### Computing Device

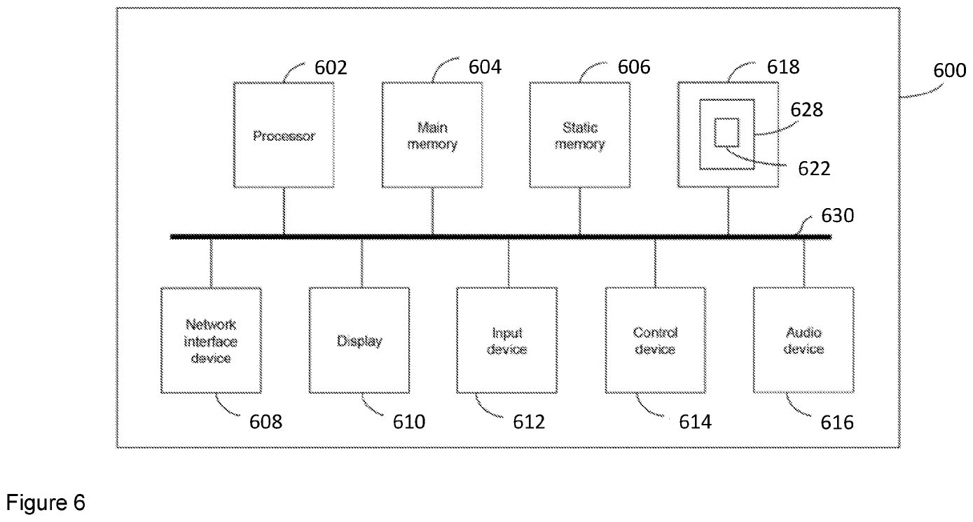

FIG. 6 illustrates a block diagram of one implementation of a computing device 600 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a secondary memory (e.g., a data storage device 618), which communicate with each other via a bus 630.

Processing device 602 represents one or more general-purpose processors such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute the processing logic (instructions 622) for performing the operations and steps discussed herein.

The computing device 600 may further include a network interface device 608. The computing device 600 also may include a video display unit 610 (e.g., a liquid crystal display (LCD) or a cathode ray tube (CRT)), an alphanumeric input device 612 (e.g., a keyboard or touchscreen), a cursor control device 614 (e.g., a mouse or touchscreen), and an audio device 616 (e.g., a speaker).

The data storage device 618 may include one or more machine-readable storage media (or more specifically one or more non-transitory computer-readable storage media) 628 on which is stored one or more sets of instructions 622 embodying any one or more of the methodologies or functions described herein. The instructions 622 may also reside, completely or at least partially, within the main memory 604 and/or within the processing device 602 during execution thereof by the computer system 600, the main memory 604 and the processing device 602 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “obtaining”, “determining”, “comparing”, “extracting”, “normalising,” “generating”, “providing”, “applying”, “training”, “feeding”, “cropping”, “mapping”, “selecting”, “evaluating”, “assigning”, “computing”, “calculating”, or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognised that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method of controlling operation of a water distribution network, WDN, comprising:
(a) obtaining data pertaining to parameters of the WDN;
(b) comparing the data with a hydraulic model of the WDN;
(c) determining an error value based on the comparing the data with the hydraulic model;
(d) determining that the error value is below a threshold;
(e) using the data to obtain an updated hydraulic model; and
(f) using the updated hydraulic model to control one or more elements of the WDN.

2. The method of claim 1, the method further comprises:
(g) obtaining further data pertaining to parameters of the WDN;
(h) comparing the further data with the updated hydraulic model of the WDN;
(i) determining a further error value based on the comparing the further data with the updated hydraulic model;
(j) determining that the further error value is below the threshold;
(k) using the data to obtain a further updated hydraulic model; and
(l) using the further updated hydraulic model to control one or more elements of the WDN.

3. The method of claim 2, wherein steps (g) to (l) are repeated over time.

4. The method of claim 1, wherein if the error value is above the threshold, the method further comprises:
determining that the error value is not due to a fault in the WDN; and
if the error value is not due to a fault, performing steps (e)-(f).

5. The method of claim 4, wherein determining that the error is not due to a fault in the WDN is performed using a density based anomaly detection method.

6. The method of claim 1, wherein determining an error value based on the comparing the data with the hydraulic model comprises determining a difference between the data and corresponding values in the hydraulic model and using the difference as the error value.

7. The method of claim 1, wherein the WDN comprises at least one of pipes, pumping stations, control valves, and reservoirs for supply of treated and untreated water.

8. The method of claim 1, wherein the data comprises passively observed naturally occurring variations in the state of the WDN over the particular time interval and wherein the data is obtained using one or more sensors and/or one or more flow meters in the hydraulic network.

9. The method of claim 1, wherein the parameters of the WDN comprise at least one of pressure data of the WDN, flow rate data of the WDN, state of pumps, state of control valves, and state of tanks.

10. The method of claim 1, wherein using the data to obtain an updated hydraulic model comprises:
using the data to identify one or more states of the WDN; and
using the one or more states to obtain the updated hydraulic model.

11. The method of claim 1, wherein using the data to obtain an updated hydraulic model comprises:
controlling the one or more elements of the WDN to alter the parameters of the WDN;
obtaining modified data pertaining to the altered parameters of the WDN;
generating one or more states of the WDN based on the modified data; and
using the one or more states to obtain the updated hydraulic model.

12. The method of claim 11, wherein controlling the one or more elements of the WDN is contingent on a pressure in the WDN not exceeding pre-defined safe pressure bounds.

13. The method of any claim 10, wherein the one or more states of the WDN comprise pressure and flow data.

14. The method of claim 10, wherein using the one or more states to obtain the updated model comprises:
adding the one or more states to a historic set of states of the WDN;
adaptively sampling from the historic set of states to obtain a plurality of sampled states; and
updating the hydraulic model using the plurality of sampled states to obtain the updated hydraulic model.

15. The method of claim 14, wherein adaptively sampling comprises using a principal component analysis, PCA, algorithm to identify, from a set of states of the WDN in the data, an optimal set of states, and using the optimal set of states as the plurality of sampled states.

16. The method of claim 14, wherein updating the hydraulic model using the plurality of sampled states comprises calibrating the hydraulic model with the plurality of sampled states using a sequential convex programming, SCP, algorithm.

17. The method of claim 1, wherein the particular time interval is periodic and is a regular or irregular interval with an upper limit of 24 hours.

18. The method of claim 1, wherein the threshold is defined based on the one or more elements that are controlled using the updated model, and wherein the one or more elements are at least one of pumps and valves.

19. The method of claim 1, wherein the maintenance of the WDN is performed over a network.

20. A computer readable medium on which are stored instructions that cause one or more processors to perform the method according to claim 1 when the instructions are executed by the one or more processors.

21. A computer system comprising one or more processors, configured to perform the method according to claim 1.

22. A computer implemented method for maintenance of a hydraulic model of a water distribution network, comprising:
(a) obtaining data pertaining to parameters of the WDN;
(b) comparing the data with a hydraulic model of the WDN;
(c) determining an error value based on the comparing the data with the hydraulic model;
(d) determining that the error value is below a threshold; and
(e) using the data to obtain an updated hydraulic model.
